(19) United States
(12) Patent Application Publication
(10) Pub. No.: US 2025/0246924 A1
(43) Pub. Date: Jul. 31, 2025

(54) ELECTRICAL POWER SUPPLY SYSTEM AND MOVING OBJECT

(71) Applicant: HONDA MOTOR CO., LTD., Tokyo (JP)

(72) Inventor: Manabu Mitani, Wako-shi (JP)

(21) Appl. No.: 19/017,997

(22) Filed: Jan. 13, 2025

(30) Foreign Application Priority Data
Jan. 25, 2024 (JP) 2024-009127

(51) Int. Cl. H02J 7/00; B64C 29/00; B64D 27/35

(52) U.S. Cl. CPC H02J 7/0063; H02J 7/0047; B64C 29/0091; B64D 27/35

(57) ABSTRACT

An electrical power supply system is equipped with a first switching device disposed on a first wire of an electrical power supply circuit, a second switching device disposed on a second wire of the electrical power supply circuit, a third switching device disposed on a third wire that bypasses the first switching device, a fourth switching device disposed on a fourth wire that is connected to the third wire and the second wire, and resistors disposed in at least two portions from among a first portion on the third wire, a second portion on the fourth wire, and a third portion on the third wire.

### CROSS-REFERENCE TO RELATED APPLICATIONS

This application is based upon and claims the benefit of priority from Japanese Patent Application No. 2024-009127 filed on Jan. 25, 2024, the contents of which are incorporated herein by reference.

### BACKGROUND OF THE INVENTION

### Field of the Invention

The present disclosure relates to an electrical power supply system and a moving object.

### Description of the Related Art

In JP 2010-141958 A, an electrical power supply system is disclosed which is equipped with a high-voltage battery and a motor generator. Between the high-voltage battery and the motor generator, three relays, a resistor (a precharging resistor), a capacitor (a smoothing capacitor), and a step-down converter are interposed. In such an electrical power supply system, by controlling ON and OFF states of the three relays, the capacitor is capable of being precharged via the resistor. Further, in such an electrical power supply system, by controlling the ON and OFF states of the three relays, an electrical charge that is stored in the capacitor can be discharged via the resistor.

### SUMMARY OF THE INVENTION

There is a desire for a more satisfactory electrical power supply system and a more satisfactory moving object.

The present invention has the object of solving the aforementioned problem.

A first aspect of the present disclosure is characterized by an electrical power supply system including an electrical power supply circuit configured to supply electrical power from an electrical power storage device to a load device, the electrical power supply system comprising a first wire which is one wire from among a positive wire and a negative wire provided in the electrical power supply circuit, a first switching device disposed on the first wire, and configured to switch between a connected state in which the electrical power storage device and the load device are connected, and a disconnected state in which the electrical power storage device and the load device are disconnected, a second wire which is another wire from among the positive wire and the negative wire, a second switching device disposed on the second wire, and configured to switch between a connected state in which the electrical power storage device and the load device are connected, and a disconnected state in which the electrical power storage device and the load device are disconnected, a third wire configured to bypass the first switching device, a third switching device disposed on the third wire, and configured to switch between a connected state in which the electrical power storage device and the load device are connected, and a disconnected state in which the electrical power storage device and the load device are disconnected, a fourth wire configured to be connected to the third wire at a first node that is closer in proximity to the load device than the third switching device, and configured to be connected to the second wire at a second node that is closer in proximity to the electrical power storage device than the second switching device, a fourth switching device disposed on the fourth wire, and configured to switch between a connected state in which the third wire and the second wire are connected, and a disconnected state in which the third wire and the second wire are disconnected, and resistors disposed in at least two portions from among a first portion which is a portion of the third wire that is positioned between the electrical power storage device and the first node, a second portion which is a portion on the fourth wire, and a third portion which is a portion of the third wire that is positioned between the first node and the load device.

A second aspect of the present disclosure is characterized by an electrical power supply system including an electrical power supply circuit configured to supply electrical power from an electrical power storage device to a load device, the electrical power supply system comprising a first wire which is one wire from among a positive wire and a negative wire provided in the electrical power supply circuit, a first switching device disposed on the first wire, and configured to switch between a connected state in which the electrical power storage device and the load device are connected, and a disconnected state in which the electrical power storage device and the load device are disconnected, a second wire which is another wire from among the positive wire and the negative wire, a second switching device disposed on the second wire, and configured to switch between a connected state in which the electrical power storage device and the load device are connected, and a disconnected state in which the electrical power storage device and the load device are disconnected, a third wire configured to bypass the first switching device, a third switching device disposed on the third wire, and configured to switch between a connected state in which the electrical power storage device and the load device are connected, and a disconnected state in which the electrical power storage device and the load device are disconnected, a first resistor disposed on the third wire, and configured to be connected in series with the third switching device, a fourth wire configured to be connected to the first wire at a third node that is closer in proximity to the load device than the first switching device, and configured to be connected to the second wire at a fourth node that is closer in proximity to the electrical power storage device than the second switching device, a fourth switching device disposed on the fourth wire, and configured to switch between a connected state in which the third wire and the second wire are connected, and a disconnected state in which the third wire and the second wire are disconnected, and a second resistor disposed on the fourth wire, and configured to be connected in series with the fourth switching device.

A third aspect of the present disclosure is characterized by a moving object comprising the electrical power supply system according to the first aspect.

According to the present invention, it is possible to provide a more satisfactory electrical power supply system and a more satisfactory moving object.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of an electrical power supply system according to a first embodiment;

FIG. 2 is a control block diagram of a control device according to the first embodiment;

FIG. 3 is a flowchart showing operations of the electrical power supply system according to the first embodiment;

FIG. 4 is a diagram showing operations of the electrical power supply system in a system startup preparation process according to the first embodiment;

FIG. 5 is a diagram showing operations of the electrical power supply system in a system operation process according to the first embodiment;

FIG. 6 is a diagram showing operations of the electrical power supply system in a system operation shutdown process according to the first embodiment;

FIG. 7 is a process flow of a process of determining whether or not discharging is necessary according to the first embodiment;

FIG. 8 is a diagram showing operations of the electrical power supply system in an electrical power storage device discharging process according to the first embodiment;

FIG. 9 is a diagram showing operations of an electrical power supply system according to a comparative example;

FIG. 10 is a diagram showing operations of the electrical power supply system according to the comparative example;

FIG. 11 is a diagram showing operations of the electrical power supply system according to the comparative example;

FIG. 12A is a time chart showing a time-voltage relationship according to the comparative example;

FIG. 12B is a time chart showing a time-current relationship according to the comparative example;

FIG. 13 is a diagram showing a state of the electrical power supply system in the case that a fourth switching device operates erroneously during the system startup preparation process and has become placed in a connected state (ON);

FIG. 14 is a diagram showing a state of the electrical power supply system in the case that the fourth switching device operates erroneously during the system operation process and has become placed in a connected state (ON);

FIG. 15 is a diagram showing a state of the electrical power supply system in the case that a third switching device operates erroneously during the electrical power storage device discharging process and has become placed in a connected state (ON);

FIG. 16 is a schematic diagram of a moving object;

FIG. 17 is a schematic diagram of the electrical power supply system according to a second embodiment;

FIG. 18 is a schematic diagram of the electrical power supply system according to a third embodiment;

FIG. 19 is a schematic diagram of the electrical power supply system according to a fourth embodiment; and

FIG. 20 is a schematic diagram of the electrical power supply system according to a fifth embodiment.

### DETAILED DESCRIPTION OF THE INVENTION

In an electrical power supply system that supplies electrical power from an electrical power generating device to a first load device and a second load device, in order to respond to cases in which a relatively large amount of electrical power is requested from each of the first load device and the second load device, a first electrical power storage device may be connected in parallel with the electrical power generating device, and a second electrical power storage device may be connected in parallel with the electrical power generating device.

In the case that a comparatively large amount of electrical power is requested from the first load device, the electrical power is supplied to the first load device from the electrical power generating device and the first electrical power storage device. In the case that a comparatively large amount of electrical power is requested from the second load device, the electrical power is supplied to the second load device from the electrical power generating device and the second electrical power storage device. However, in the case that a difference between the output voltage of the first electrical power storage device and the output voltage of the second electrical power storage device is comparatively large, a concern arises in that an excessive electrical current may flow to the electrical power supply system.

The electrical power supply system disclosed herein is capable of suppressing the occurrence of an excessive electrical current in the electrical power supply system, even in the case that a difference occurs between the output voltage of the first electrical power storage device and the output voltage of the second electrical power storage device.

### First Embodiment

### [Configuration of Electrical Power Supply System]

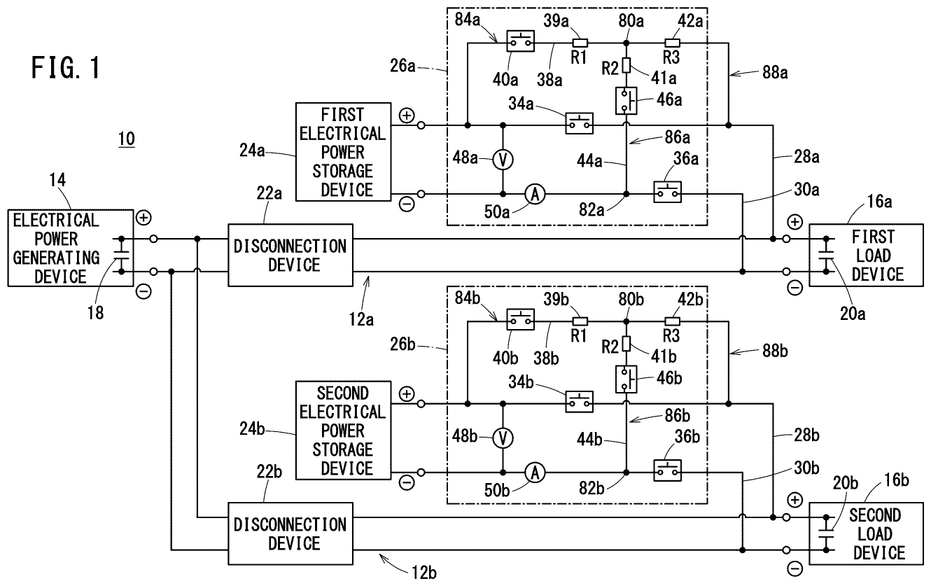

FIG. 1 is a schematic diagram of an electrical power supply system 10 according to the present embodiment. The electrical power supply system 10 is equipped with a first electrical power supply circuit 12a and a second electrical power supply circuit 12b. The first electrical power supply circuit 12a supplies a DC electrical power output from an electrical power generating device 14 to a first load device 16a. The second electrical power supply circuit 12b supplies a DC electrical power output from the electrical power generating device 14 to a second load device 16b.

The electrical power generating device 14 includes an engine, an electrical power generator, and a power control unit, none of which are shown. The electrical power generator is driven by the engine, and the electrical power generator generates a three-phase AC electrical power. The power control unit converts the three-phase AC electrical power into a DC electrical power. The electrical power generating device 14 includes a smoothing capacitor 18. At a time when the electrical power supply system 10 is started, charging (precharging) of the smoothing capacitor 18 is carried out. Further, at a time when the electrical power supply system 10 is shut down, discharging of the smoothing capacitor 18 is carried out.

The electrical power generating device 14 may include various elements, such as various sensors, fuses, relays, breakers, diodes, transistors, resistors, coils, and the like.

The first load device 16a and the second load device 16b each include an inverter and an electric motor, neither of which is shown. The inverter converts the input DC electrical power into a three-phase AC electrical power. The electric motor is driven by the three-phase AC electrical power. The first load device 16a includes a smoothing capacitor 20a. The second load device 16b includes a smoothing capacitor 20b. At a time when the electrical power supply system 10 is started, first, charging (precharging) of the smoothing capacitors 20a and 20b is carried out. Further, at a time when the electrical power supply system 10 is shut down, discharging of the smoothing capacitors 20a and 20b is carried out.

The first load device 16a and the second load device 16b may include various elements such as various sensors, fuses, relays, breakers, diodes, transistors, resistors, coils, capacitors, and the like.

The electrical power supply system 10 is equipped with disconnection devices 22a and 22b. The disconnection device 22a is capable of disconnecting the electrical power generating device 14 from the first electrical power supply circuit 12a. The disconnection device 22b is capable of disconnecting the electrical power generating device 14 from the second electrical power supply circuit 12b.

The first electrical power supply circuit 12a and the second electrical power supply circuit 12b may include constituent elements such as switching devices, sensors, fuses, diodes, resistors, coils, capacitors, and the like, in addition to the configuration described above.

The disconnection device 22a is equipped with a pair of switching devices, neither of which is shown. One of the switching devices is provided on a positive electrode wire that connects the electrical power generating device 14 and the first electrical power supply circuit 12a. Another of the switching devices is provided on a negative electrode wire that connects the electrical power generating device 14 and the first electrical power supply circuit 12a. The switching devices of the disconnection device 22a, for example, are switches, relays, contactors, breakers, semiconductor switches, or the like.

The disconnection device 22b is equipped with a pair of switching devices, neither of which is shown. One of the switching devices is provided on a positive electrode wire that connects the electrical power generating device 14 and the second electrical power supply circuit 12b. Another of the switching devices is provided on a negative electrode wire that connects the electrical power generating device 14 and the second electrical power supply circuit 12b. The switching devices of the disconnection device 22b, for example, are switches, relays, contactors, breakers, semiconductor switches, or the like.

The electrical power supply system 10 is equipped with a third electrical power supply circuit 26a and a fourth electrical power supply circuit 26b. The third electrical power supply circuit 26a supplies an electrical power from a first electrical power storage device 24a to the first load device 16a. The fourth electrical power supply circuit 26b supplies an electrical power from a second electrical power storage device 24b to the second load device 16b.

The first electrical power storage device 24a is connected to the first electrical power supply circuit 12a via the third electrical power supply circuit 26a, and in parallel with the electrical power generating device 14. A DC electrical power output from the first electrical power storage device 24a is supplied to the first load device 16a. The second electrical power storage device 24b is connected to the second electrical power supply circuit 12b via the fourth electrical power supply circuit 26b, and in parallel with the electrical power generating device 14. A DC electrical power output from the second electrical power storage device 24b is supplied to the second load device 16b.

The first electrical power storage device 24a and the second electrical power storage device 24b each include, for example, a lithium ion battery. The first electrical power storage device 24a and the second electrical power storage device 24b may include a secondary battery other than a lithium ion battery. The first electrical power storage device 24a and the second electrical power storage device 24b may each include a large-capacity capacitor.

The third electrical power supply circuit 26a is equipped with a first wire 28a, a second wire 30a, a third wire 38a, and a fourth wire 44a. Further, the third electrical power supply circuit 26a is equipped with a first switching device 34a, a second switching device 36a, a third switching device 40a, and a fourth switching device 46a.

The first wire 28a is a positive electrode wire, and connects a positive electrode terminal of the first electrical power storage device 24a and a positive wire of the first electrical power supply circuit 12a. The first switching device 34a is provided on the first wire 28a. The first switching device 34a is capable of switching between a connected state in which the first electrical power storage device 24a and the first load device 16a are connected, and a disconnected state in which the first electrical power storage device 24a and the first load device 16a are disconnected. The first switching device 34a, for example, is a switch, a relay, a contactor, a breaker, a semiconductor switch, or the like.

The second wire 30a is a negative electrode wire, and connects a negative electrode terminal of the first electrical power storage device 24a and a negative wire of the first electrical power supply circuit 12a. The second switching device 36a is provided on the second wire 30a. The second switching device 36a is capable of switching between a connected state in which the first electrical power storage device 24a and the first load device 16a are connected, and a disconnected state in which the first electrical power storage device 24a and the first load device 16a are disconnected. The second switching device 36a, for example, is a switch, a relay, a contactor, a breaker, a semiconductor switch, or the like.

One end of the third wire 38a is connected to the first wire 28a between the first electrical power storage device 24a and the first switching device 34a. Another end of the third wire 38a is connected to the first wire 28a between the first switching device 34a and the first load device 16a. More specifically, the third wire 38a bypasses the first switching device 34a. The third switching device 40a is provided on the third wire 38a, and is capable of switching between a connected state in which the first electrical power storage device 24a and the first load device 16a are connected, and a disconnected state in which the first electrical power storage device 24a and the first load device 16a are disconnected. The third switching device 40a, for example, is a switch, a relay, a contactor, a breaker, a semiconductor switch, or the like.

One end of the fourth wire 44a is connected to the third wire 38a at a first node 80a, and another end of the fourth wire 44a is connected to the second wire 30a at a second node 82a. The first node 80a is positioned on the third wire 38a. The first node 80a is positioned at a location that is closer in proximity to the first load device 16a than the third switching device 40a. The second node 82a is positioned on the second wire 30a. The second node 82a is positioned at a location that is closer in proximity to the first electrical power storage device 24a than the second switching device 36a. The fourth switching device 46a is disposed on the fourth wire 44a, and is capable of switching between a connected state in which the third wire 38a and the second wire 30a are connected, and a disconnected state in which the third wire 38a and the second wire 30a are disconnected. The fourth switching device 46a, for example, is a switch, a relay, a contactor, a breaker, a semiconductor switch, or the like.

A first resistor 39a is disposed in a first portion 84a of the third wire 38a that is positioned between the first electrical power storage device 24a and the first node 80a. The first resistor 39a is disposed at a position that is closer in proximity to the first node 80a than the third switching device 40a. The positions of the first resistor 39a and the third switching device 40a may be interchanged.

A second resistor 41a is disposed in a second portion 86a which is a portion on the fourth wire 44a. The second resistor 41a is disposed at a position that is closer in proximity to the first node 80a than the fourth switching device 46a. The positions of the second resistor 41a and the fourth switching device 46a may be interchanged.

A third resistor 42a is disposed in a third portion 88a of the third wire 38a that is positioned between the first node 80a and the first load device 16a.

A resistance value (R1) of the first resistor 39a, a resistance value (R2) of the second resistor 41a, and a resistance value (R3) of the third resistor 42a may be the same value or may be different values. In the case that the resistance value (R1) of the first resistor 39a, the resistance value (R2) of the second resistor 41a, and the resistance value (R3) of the third resistor 42a are set to the same value, a resistance value (R1+R3) in the closed circuit formed at a time when the smoothing capacitor 18 of the electrical power generating device 14 and the smoothing capacitor 20a of the first load device 16a are charged (precharged) becomes equal to a resistance value (R2+R3) in the closed circuit formed at a time when the smoothing capacitor 18 of the electrical power generating device 14 and the smoothing capacitor 20a of the first load device 16a are discharged.

The third electrical power supply circuit 26a includes a voltage sensor 48a and a current sensor 50a. The voltage sensor 48a detects the terminal voltage (the output voltage) of the first electrical power storage device 24a. A positive electrode terminal of the voltage sensor 48a is connected to the first wire 28a between the positive electrode terminal of the first electrical power storage device 24a and the first switching device 34a. A negative electrode terminal of the voltage sensor 48a is connected to the second wire 30a between the negative electrode terminal of the first electrical power storage device 24a and the second switching device 36a. The current sensor 50a is provided on the second wire 30a, at a position between the negative electrode terminal of the first electrical power storage device 24a and the second node 82a.

The fourth electrical power supply circuit 26b is equipped with a first wire 28b, a second wire 30b, a third wire 38b, and a fourth wire 44b. Further, the fourth electrical power supply circuit 26b is equipped with a first switching device 34b, a second switching device 36b, a third switching device 40b, and a fourth switching device 46b.

The first wire 28b is a positive electrode wire, and connects a positive electrode terminal of the second electrical power storage device 24b and a positive wire of the second electrical power supply circuit 12b. The first switching device 34b is provided on the first wire 28b. The first switching device 34b is capable of switching between a connected state in which the second electrical power storage device 24b and the second load device 16b are connected, and a disconnected state in which the second electrical power storage device 24b and the second load device 16b are disconnected. The first switching device 34b, for example, is a switch, a relay, a contactor, a breaker, a semiconductor switch, or the like.

The second wire 30b is a negative electrode wire, and connects a negative electrode terminal of the second electrical power storage device 24b and a negative wire of the second electrical power supply circuit 12b. The second switching device 36b is provided on the second wire 30b. The second switching device 36b is capable of switching between a connected state in which the second electrical power storage device 24b and the second load device 16b are connected, and a disconnected state in which the second electrical power storage device 24b and the second load device 16b are disconnected. The second switching device 36b, for example, is a switch, a relay, a contactor, a breaker, a semiconductor switch, or the like.

One end of the third wire 38b is connected to the first wire 28b between the second electrical power storage device 24b and the first switching device 34b. Another end of the third wire 38b is connected to the first wire 28b between the first switching device 34b and the second load device 16b. More specifically, the third wire 38b bypasses the first switching device 34b. The third switching device 40b is provided on the third wire 38b, and is capable of switching between a connected state in which the second electrical power storage device 24b and the second load device 16b are connected, and a disconnected state in which the second electrical power storage device 24b and the second load device 16b are disconnected. The third switching device 40b, for example, is a switch, a relay, a contactor, a breaker, a semiconductor switch, or the like.

One end of the fourth wire 44b is connected to the third wire 38b at a first node 80b, and another end of the fourth wire 44b is connected to the second wire 30b at a second node 82b. The first node 80b is positioned on the third wire 38b. The first node 80b is positioned at a location that is closer in proximity to the second load device 16b than the third switching device 40b. The second node 82b is positioned on the second wire 30b. The second node 82b is positioned at a location that is closer in proximity to the second electrical power storage device 24b than the second switching device 36b. The fourth switching device 46b is provided on the fourth wire 44b, and is capable of switching between a connected state in which the third wire 38b and the second wire 30b are connected, and a disconnected state in which the third wire 38b and the second wire 30b are disconnected. The fourth switching device 46b, for example, is a switch, a relay, a contactor, a breaker, a semiconductor switch, or the like.

A first resistor 39b is disposed in a first portion 84b of the third wire 38b that is positioned between the second electrical power storage device 24b and the first node 80b. The first resistor 39b is disposed at a position that is closer in proximity to the first node 80b than the third switching device 40b. The positions of the first resistor 39b and the third switching device 40b may be interchanged.

A second resistor 41b is disposed in a second portion 86b which is a portion on the fourth wire 44b. The second resistor 41b is disposed at a position that is closer in proximity to the first node 80b than the fourth switching device 46b. The positions of the second resistor 41b and the fourth switching device 46b may be interchanged.

A third resistor 42b is disposed in a third portion 88b of the third wire 38b that is positioned between the first node 80b and the second load device 16b.

A resistance value (R1) of the first resistor 39b, a resistance value (R2) of the second resistor 41b, and a resistance value (R3) of the third resistor 42b may be the same value or may be different values. In the case that the resistance value (R1) of the first resistor 39b, the resistance value (R2) of the second resistor 41b, and the resistance value (R3) of the third resistor 42b are set to the same value, a resistance value (R1+R3) in the closed circuit formed at a time when the smoothing capacitor 18 of the electrical power generating device 14 and the smoothing capacitor 20b of the second load device 16b are charged becomes equal to a resistance value (R2+R3) in the closed circuit formed at a time when the smoothing capacitor 18 of the electrical power generating device 14 and the smoothing capacitor 20b of the second load device 16b are discharged.

Moreover, according to the present disclosure, although the resistance value of the first resistor 39a and the resistance value of the first resistor 39b are indicated as R1, the resistance value of the first resistor 39a and the resistance value of the first resistor 39b may be different from each other. Similarly, although the resistance value of the second resistor 41a and the resistance value of the second resistor 41b are indicated as R2, the resistance value of the second resistor 41a and the resistance value of the second resistor 41b may be different from each other. Further, although the resistance value of the third resistor 42a and the resistance value of the third resistor 42b are indicated as R3, the resistance value of the third resistor 42a and the resistance value of the third resistor 42b may be different from each other.

The fourth electrical power supply circuit 26b includes a voltage sensor 48b and a current sensor 50b. The voltage sensor 48b detects the terminal voltage (the output voltage) of the second electrical power storage device 24b. A positive electrode terminal of the voltage sensor 48b is connected to the first wire 28b between the positive electrode terminal of the second electrical power storage device 24b and the first switching device 34b. A negative electrode terminal of the voltage sensor 48b is connected to the second wire 30b between the negative electrode terminal of the second electrical power storage device 24b and the second switching device 36b. The current sensor 50b is provided on the second wire 30b, at a position between the negative electrode terminal of the second electrical power storage device 24b and the second node 82b.

### [Configuration of Control Device]

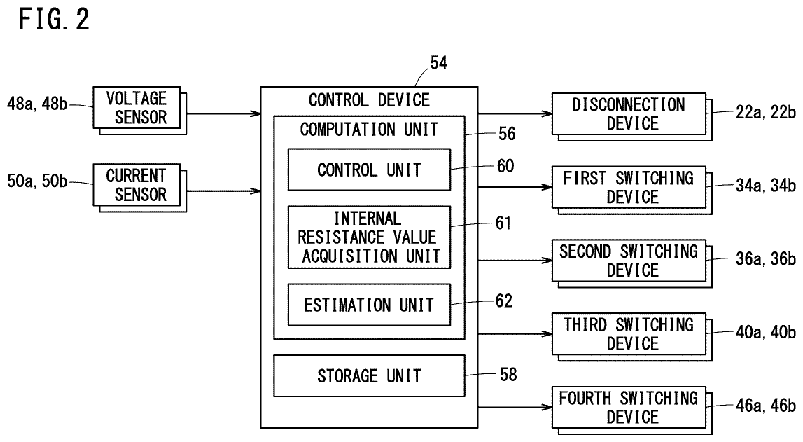

The electrical power supply system 10 is equipped with a control device 54. FIG. 2 is a control block diagram of the control device 54 in the present embodiment. The control device 54 acquires signals indicative of the voltage from the voltage sensors 48a and 48b. The control device 54 acquires signals indicative of the current from the current sensors 50a and 50b. The control device 54 controls each of the switching devices (each of the switching devices of the disconnection devices 22a and 22b, the first switching devices 34a and 34b, the second switching devices 36a and 36b, the third switching devices 40a and 40b, and the fourth switching devices 46a and 46b).

The control device 54 includes a computation unit 56 and a storage unit 58. The computation unit 56 includes a processor such as a CPU (Central Processing Unit) or a GPU (Graphics Processing Unit) or the like. The computation unit 56 controls each of the devices by executing a program that is stored in the storage unit 58. At least a portion of the computation unit 56 may be realized by an integrated circuit such as an ASIC (Application Specific Integrated Circuit) or an FPGA (Field-Programmable Gate Array) or the like. At least a portion of the computation unit 56 may be realized by an electronic circuit including a discrete device.

The computation unit 56 functions as a control unit 60, an internal resistance value acquisition unit 61, and an estimation unit 62. The control unit 60 can cause the electrical power supply system 10 to selectively execute a system startup preparation process, a system operation process, a system shutdown process, and an electrical power storage device discharging process, all of which will be described later. Specifically, the control unit 60 can control the connected state (ON) and disconnected state (OFF) of each of the switching devices provided in the electrical power supply system 10, and thereby cause each of such processes to be executed. The internal resistance value acquisition unit 61 acquires the internal resistance values of the first electrical power storage device 24a and the second electrical power storage device 24b. The estimation unit 62, based on the internal resistance value of the first electrical power storage device 24a, estimates a state of deterioration of the first electrical power storage device 24a. The estimation unit 62, based on the internal resistance value of the second electrical power storage device 24b, estimates a state of deterioration of the second electrical power storage device 24b.

The storage unit 58 is constituted by a non-illustrated volatile memory and a non-illustrated non-volatile memory, which are computer readable non-transitory storage media. The volatile memory, for example, is a RAM (Random Access Memory) or the like. The non-volatile memory, for example, is a ROM (Read Only Memory), a flash memory, or the like. Data and the like are stored, for example, in the volatile memory. A program, a table, a map and the like are stored, for example, in the non-volatile memory. At least a portion of the storage unit 58 may be provided in the processor, the integrated circuit, or the like that has been described above.

### [Operations of Electrical Power Supply System]

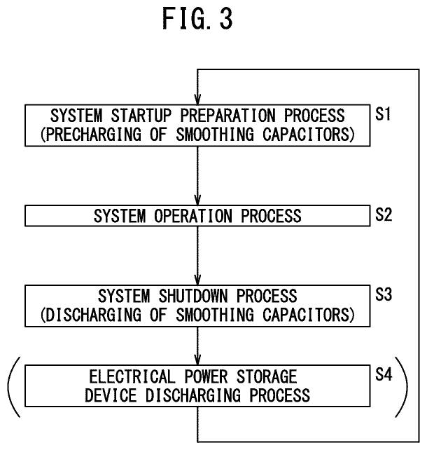

FIG. 3 is a flowchart showing operations of the electrical power supply system 10 according to the present embodiment. The electrical power supply system 10 is capable of repeatedly carrying out a series of processes including a system startup preparation process (step S1), a system operation process (step S2), and a system shutdown process (step S3). Furthermore, in a period from the system shutdown process to a subsequent system startup preparation process, the electrical power supply system 10 is capable of carrying out an electrical power storage device discharging process (step S4), as necessary. Hereinafter, the operations of the electrical power supply system 10 in each of the processes will be described.

Moreover, hereinafter, a description will be given concerning the operation of the disconnection device 22a in the first electrical power supply circuit 12a, and the operation of each of the first switching device 34a, the second switching device 36a, the third switching device 40a, and the fourth switching device 46a of the third electrical power supply circuit 26a in each of the processes. Concerning the operation of the disconnection device 22b in the second electrical power supply circuit 12b, and the operation of each of the first switching device 34b, the second switching device 36b, the third switching device 40b, and the fourth switching device 46b of the fourth electrical power supply circuit 26b in each of the processes, these operations are the same as the operation of the disconnection device 22a in the first electrical power supply circuit 12a, and the operation of each of the first switching device 34a, the second switching device 36a, the third switching device 40a, and the fourth switching device 46a of the third electrical power supply circuit 26a in each of the processes, and therefore, descriptions of such operations are omitted herein.

### [Operations of Electrical Power Supply System in System Startup Preparation Process]

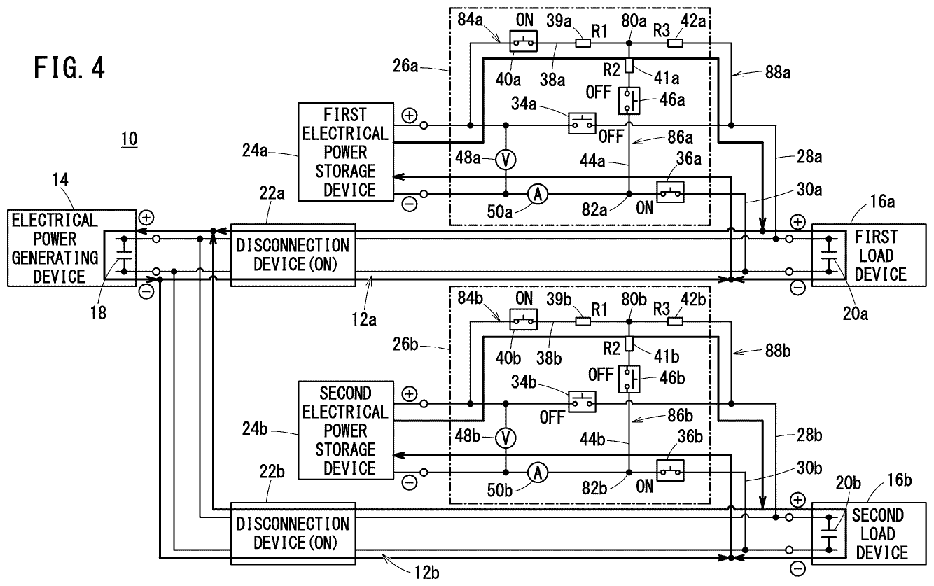

FIG. 4 is a diagram showing operations of the electrical power supply system 10 in the system startup preparation process according to the present embodiment. For example, when the user manually turns ON a non-illustrated electrical power supply switch or the like, the control unit 60 starts up the electrical power supply system 10. In the system startup preparation process, the control unit 60 controls each of the switching devices to carry out precharging of the smoothing capacitors 18 and 20a.

The control unit 60 sets the pair of switching devices of the disconnection device 22a in the connected state (ON). Further, the control unit 60 controls each of the switching devices of the third electrical power supply circuit 26a in the following manner. The control unit 60 sets the first switching device 34a in the disconnected state (OFF), sets the second switching device 36a in the connected state (ON), sets the third switching device 40a in the connected state (ON), and sets the fourth switching device 46a in the disconnected state (OFF).

In accordance with this feature, a closed circuit is formed that runs from the first electrical power storage device 24a, by way of the third switching device 40a, the first resistor 39a, the third resistor 42a, the disconnection device 22a, the smoothing capacitor 18, and the second switching device 36a, and returns to the first electrical power storage device 24a. Further, a closed circuit is formed that runs from the first electrical power storage device 24a, by way of the third switching device 40a, the first resistor 39a, the third resistor 42a, the smoothing capacitor 20a, and the second switching device 36a, and returns to the first electrical power storage device 24a.

In this case, an electrical current flows through a pathway indicated by the arrows shown in FIG. 4. A DC electrical power is supplied to the smoothing capacitor 18 from the first electrical power storage device 24a via the first resistor 39a and the third resistor 42a. In accordance with this feature, an electrical charge is stored in the smoothing capacitor 18, and thereby the smoothing capacitor 18 is charged. Similarly, a DC electrical power is supplied to the smoothing capacitor 20a from the first electrical power storage device 24a via the first resistor 39a and the third resistor 42a. An electrical charge is stored in the smoothing capacitor 20a, and thereby the smoothing capacitor 20a is charged. By the smoothing capacitors 18 and 20a reaching a predetermined voltage, the system startup preparation process is completed.

### [Operations of Electrical Power Supply System in System Operation Process]

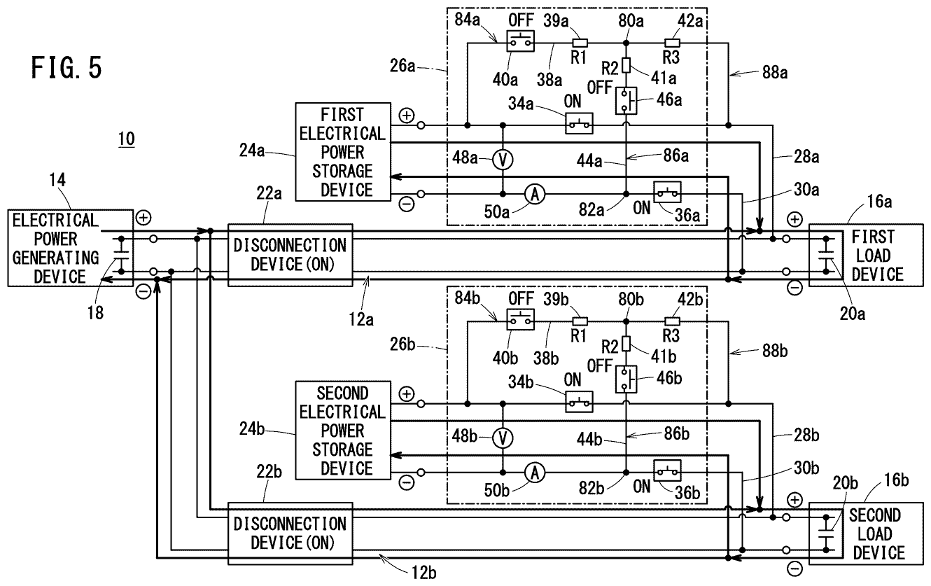

FIG. 5 is a diagram showing operations of the electrical power supply system 10 in the system operation process according to the present embodiment. After the system startup preparation process has completed, the control unit 60 controls each of the switching devices to supply a DC electrical power to the first load device 16a.

The control unit 60 sets the pair of switching devices of the disconnection device 22a in the connected state (ON). Further, the control unit 60 controls each of the switching devices of the third electrical power supply circuit 26a in the following manner. The control unit 60 sets the first switching device 34a in the connected state (ON), sets the second switching device 36a in the connected state (ON), sets the third switching device 40a in the disconnected state (OFF), and sets the fourth switching device 46a in the disconnected state (OFF).

In this state, the electrical power generating device 14 is started using the electrical power supplied from at least one of the first electrical power storage device 24a or the second electrical power storage device 24b. Consequently, starting of the electrical power supply system 10 is completed. After starting of the electrical power supply system 10 is completed, a DC electrical power is supplied from the electrical power generating device 14 to the first load device 16a. Alternatively, after starting of the electrical power supply system 10 is completed, a DC electrical power is supplied from the electrical power generating device 14 and the first electrical power storage device 24a to the first load device 16a.

During the system operation process, in the case that an abnormality has occurred in the electrical power generating device 14, the control unit 60 sets the pair of switching devices of the disconnection device 22a in the disconnected state (OFF). In this case, a DC electrical power is supplied from the first electrical power storage device 24a to the first load device 16a. In accordance with this feature, even in the case that an abnormality has occurred in the electrical power generating device 14, the supply of the electrical power to the first load device 16a can be continued.

During the system operation process, in the case that an abnormality has occurred in the first load device 16a, the control unit 60 sets the pair of switching devices of the disconnection device 22a in the disconnected state (OFF). In accordance with this feature, even in the case that an abnormality has occurred in the first load device 16a, driving of the second load device 16b can be continued.

### [Operations of Electrical Power Supply System in System Shutdown Process]

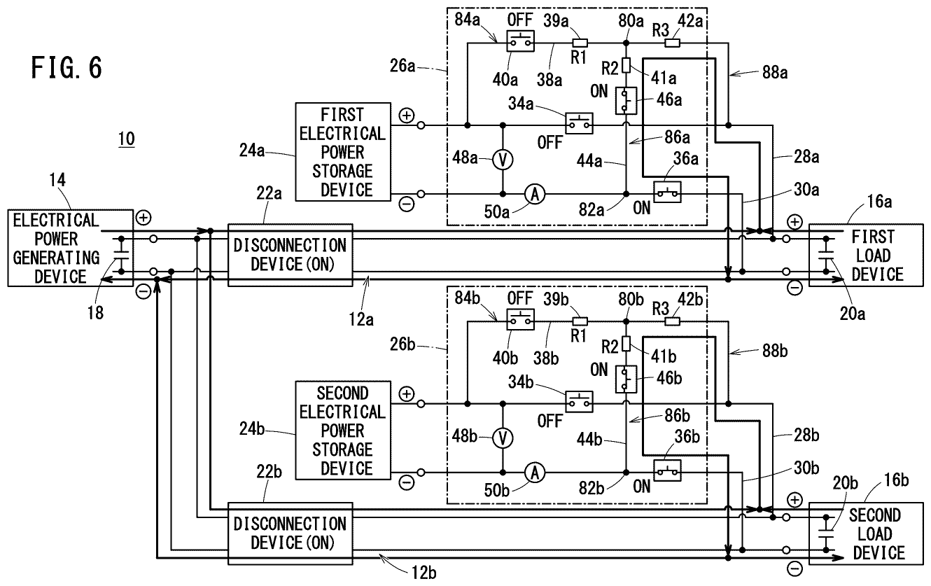

FIG. 6 is a diagram showing operations of the electrical power supply system 10 in the system shutdown process according to the present embodiment. When the user performs an OFF operation using a manual electrical power source switching device or the like, the control unit 60 causes the electrical power supply system 10 to shut down. The control unit 60 controls each of the switching devices to carry out discharging of the smoothing capacitors 18 and 20a.

The control unit 60 sets the pair of switching devices of the disconnection device 22a in the connected state (ON). Further, the control unit 60 controls each of the switching devices of the third electrical power supply circuit 26a in the following manner. The control unit 60 sets the first switching device 34a in the disconnected state (OFF), sets the second switching device 36a in the connected state (ON), sets the third switching device 40a in the disconnected state (OFF), and sets the fourth switching device 46a in the connected state (ON).

In accordance with this feature, a closed circuit is formed that runs from the smoothing capacitor 18, by way of the disconnection device 22a, the third resistor 42a, the second resistor 41a, the fourth switching device 46a, the second switching device 36a, and the disconnection device 22a, and returns to the smoothing capacitor 18. Further, a closed circuit is formed that runs from the smoothing capacitor 20a, by way of the third resistor 42a, the second resistor 41a, the fourth switching device 46a, and the second switching device 36a, and returns to the smoothing capacitor 20a.

In this case, an electrical current flows through a pathway indicated by the arrows shown in FIG. 6. Consequently, the electrical charge that is stored in the smoothing capacitor 18 is discharged. Further, the electrical charge that is stored in the smoothing capacitor 20a is discharged.

### [Operations of Electrical Power Supply System in Electrical Power Storage Device Discharging Process]

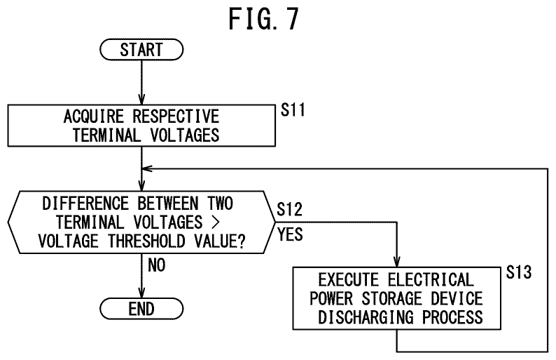

FIG. 7 is a process flow of a process of determining whether or not discharging is necessary according to the present embodiment. The control unit 60 carries out the process of determining whether or not discharging is necessary shown in FIG. 7 between the system shutdown process and the system startup preparation process. For example, the control unit 60 may carry out the process of determining whether or not discharging is necessary periodically, may carry out the process of determining whether or not discharging is necessary at a predetermined timing, or may carry out the process of determining whether or not discharging is necessary in response to a request from the user. The process of determining whether or not discharging is necessary is a process for the purpose of determining whether or not it is necessary to execute the electrical power storage device discharging process, which will be described later, prior to execution of a subsequent system startup preparation process.

In step S11, based on the detection result of the voltage sensor 48a and the detection result of the voltage sensor 48b, the control unit 60 acquires information in relation to the respective terminal voltages of the first electrical power storage device 24a and the second electrical power storage device 24b.

In step S12, the control unit 60 compares whether or not the difference between the terminal voltage of the first electrical power storage device 24a and the terminal voltage of the second electrical power storage device 24b acquired in step S11 is greater than a voltage threshold value. The voltage threshold value is a value for the purpose of determining whether or not an excessive electrical current occurs in the circuit of the electrical power supply system 10. The voltage threshold value is preferably a comparatively small value. A description will be given later concerning such an excessive electrical current. The voltage threshold value is stored beforehand in the storage unit 58.

In the case that the difference between the terminal voltage of the first electrical power storage device 24a and the terminal voltage of the second electrical power storage device 24b is greater than the voltage threshold value (step S12: YES), the process transitions to step S13. On the other hand, in the case that the difference between the terminal voltage of the first electrical power storage device 24a and the terminal voltage of the second electrical power storage device 24b is less than or equal to the voltage threshold value (step S12: NO), the process of determining whether or not discharging is necessary shown in FIG. 7 comes to an end. In this case, in a period until a subsequent system startup preparation process, execution of the electrical power storage device discharging process is unnecessary.

In the case of transitioning from step S12 to step S13, the control unit 60 executes the electrical power storage device discharging process. In this case, the control unit 60 continues to execute the electrical power storage device discharging process described later, until the difference between the terminal voltage of the first electrical power storage device 24a and the terminal voltage of the second electrical power storage device 24b becomes less than or equal to the voltage threshold value.

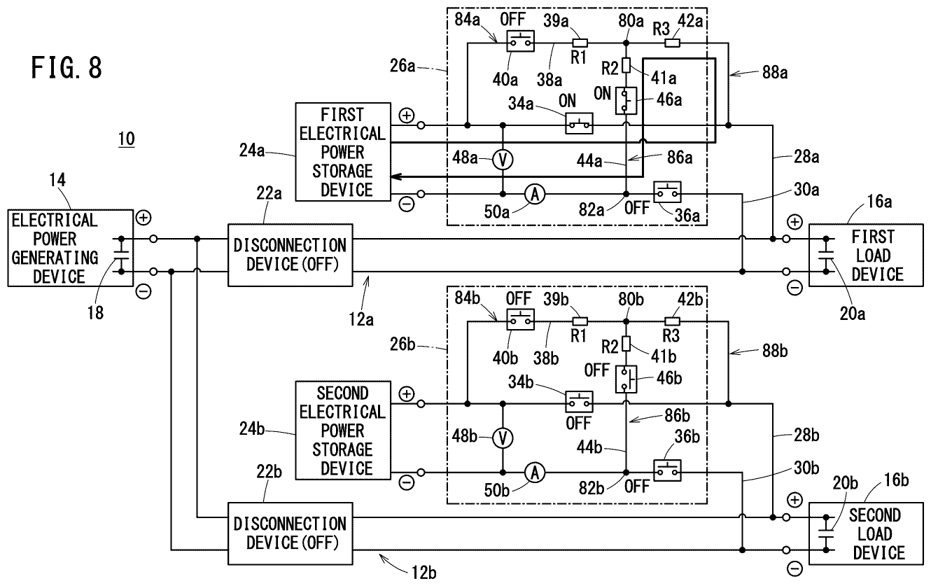

FIG. 8 is a diagram showing operations of the electrical power supply system 10 in the electrical power storage device discharging process according to the present embodiment. As noted previously, the control unit 60 carries out the electrical power storage device discharging process, until the difference between the terminal voltage of the first electrical power storage device 24a and the terminal voltage of the second electrical power storage device 24b becomes less than or equal to the voltage threshold value. Moreover, in the following, as an example, a case will be described in which the terminal voltage of the first electrical power storage device 24a is higher than the terminal voltage of the second electrical power storage device 24b.

The control unit 60 sets the pair of switching devices of the disconnection device 22a in the disconnected state (OFF). Further, the control unit 60 controls each of the switching devices of the third electrical power supply circuit 26a in the following manner. The control unit 60 sets the first switching device 34a in the connected state (ON), sets the second switching device 36a in the disconnected state (OFF), sets the third switching device 40a in the disconnected state (OFF), and sets the fourth switching device 46a in the connected state (ON). In accordance with this feature, a closed circuit is formed that runs from the first electrical power storage device 24a, by way of the first switching device 34a, the third resistor 42a, and the second resistor 41a, and returns to the first electrical power storage device 24a.

Consequently, the electrical current flows through a pathway indicated by the arrows shown in FIG. 8. The electrical power of the first electrical power storage device 24a is consumed in the second resistor 41a and the third resistor 42a. In this state, the electrical power is not supplied from the first electrical power storage device 24a to the first load device 16a. The control unit 60 switches the first switching device 34a and the fourth switching device 46a to the disconnected state (OFF), at a point in time at which the difference between the terminal voltage of the first electrical power storage device 24a and the terminal voltage of the second electrical power storage device 24b has become less than or equal to the voltage threshold value.

### [Process of Estimating State of Deterioration of Electrical Power Storage Device]

The internal resistance value acquisition unit 61 acquires the internal resistance value of the first electrical power storage device 24a. The estimation unit 62, based on the acquired internal resistance value, estimates the state of deterioration of the first electrical power storage device 24a. The state of deterioration of the first electrical power storage device 24a is also referred to as an SOH (State Of Health).

The internal resistance value acquisition unit 61 acquires an internal resistance value (r) of the first electrical power storage device 24a, for example, from the following Equation (1).

r=(Vocv−Vccv)/i (1)
Vocv: terminal voltage of the electrical power storage device in a non-discharging state
Vccv: terminal voltage of the electrical power storage device during discharging
i: electrical current during discharging
r: internal resistance value of the electrical power storage device

During the electrical power storage device discharging process for the first electrical power storage device 24a, the internal resistance value acquisition unit 61 acquires the terminal voltage (Vccv) of the first electrical power storage device 24a based on the detection result of the voltage sensor 48a. Before execution or after execution of the electrical power storage device discharging process for the first electrical power storage device 24a, the internal resistance value acquisition unit 61 acquires the terminal voltage (Vocv) of the first electrical power storage device 24a based on the detection result of the voltage sensor 48a. During the electrical power storage device discharging process for the first electrical power storage device 24a, the internal resistance value acquisition unit 61 acquires the electrical current (i) based on the detection result of the current sensor 50a.

The estimation unit 62 estimates the SOH of the first electrical power storage device 24a, in accordance with the internal resistance value (r) acquired by the internal resistance value acquisition unit 61, and the internal resistance value of the first electrical power storage device 24a prior to deterioration which is stored beforehand in the storage unit 58. The estimation unit 62 may store the estimation result in the storage unit 58, and may display the estimation result on a non-illustrated display device.

The resistance value of the second resistor 41a and the resistance value of the third resistor 42a are constant. Therefore, during the electrical power storage device discharging process, the electrical current (i) can be regarded as being constant within a time period in which the change in SOH is negligible. Stated otherwise, the internal resistance value (r) of the first electrical power storage device 24a, which is calculated by the above-described Equation (1), can be regarded as being constant within the aforementioned time period in which the change in the SOH is negligible. Therefore, according to the present embodiment, a highly reliable SOH can be obtained.

[Comparison with Comparative Example]

According to the present embodiment, the fourth wire 44a and the fourth switching device 46a are provided in the third electrical power supply circuit 26a. According to the present embodiment, discharging of the first electrical power storage device 24a can be carried out without supplying an electrical power to the first load device 16a. Similarly, according to the present embodiment, the fourth wire 44b and the fourth switching device 46b are provided in the fourth electrical power supply circuit 26b. According to the present embodiment, discharging of the second electrical power storage device 24b can be carried out without supplying an electrical power to the second load device 16b.

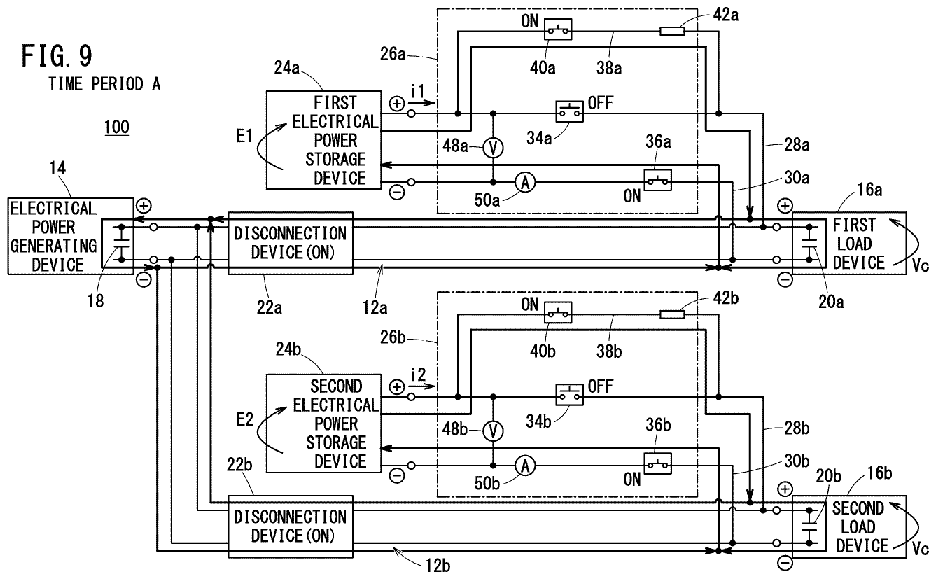

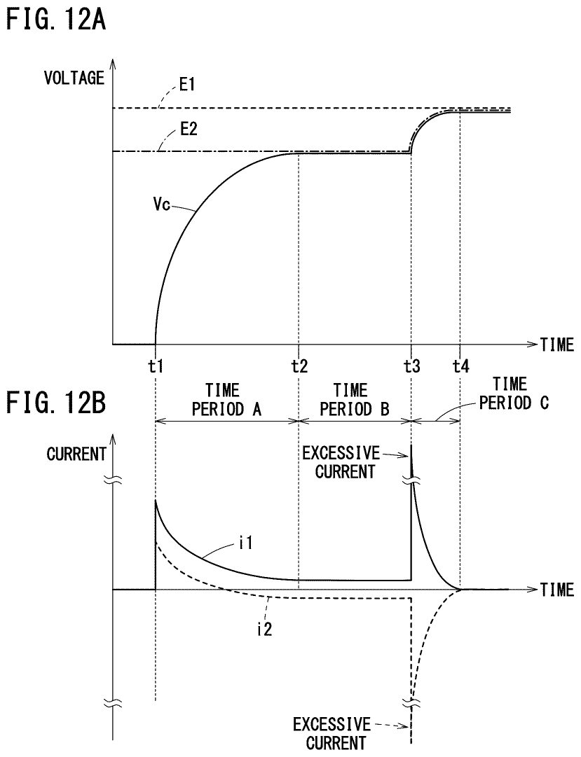

In order to facilitate understanding of the advantageous effects achieved by the present embodiment, a comparative example will be described. In this instance, with reference to FIG. 9 to FIG. 11, FIG. 12A, and FIG. 12B, a description will be given concerning an electrical power supply system 100 according to a comparative example. FIG. 9 to FIG. 11 are diagrams showing operations of the electrical power supply system 100 according to the comparative example. FIG. 12A is a time chart showing a time-voltage relationship according to the comparative example. FIG. 12B is a time chart showing a time-current relationship according to the comparative example. The electrical power supply system 100 according to the comparative example has the same configuration as the electrical power supply system 10 according to the present embodiment, except that the former does not include the fourth wires 44a and 44b, the fourth switching devices 46a and 46b, the first resistors 39a and 39b, and the second resistors 41a and 41b.

Hereinafter, an operating state of the electrical power supply system 100, from the starting of the system startup preparation process (precharging) until just after the starting of the system operation process will be described. At the point in time of the starting of the system startup preparation process, the terminal voltage of the first electrical power storage device 24a is defined as E1, and the terminal voltage of the second electrical power storage device 24b is defined as E2. The inequality E1>E2 holds true, and further, the value of E1−E2 is greater than the voltage threshold value.

At time t1 shown in FIG. 12A and FIG. 12B, the system startup preparation process is started. In the system startup preparation process, in order to charge the smoothing capacitor 18 of the electrical power generating device 14 and the smoothing capacitor 20a of the first load device 16a, as shown in FIG. 9, the pair of switching devices of the disconnection device 22a are set in the connected state (ON), the first switching device 34a is set in the disconnected state (OFF), the second switching device 36a is set in the connected state (ON), and the third switching device 40a is set in the connected state (ON). Further, in the system startup preparation process, in order to charge the smoothing capacitor 18 of the electrical power generating device 14 and the smoothing capacitor 20b of the second load device 16b, the pair of switching devices of the disconnection device 22b are set in the connected state (ON), the first switching device 34b is set in the disconnected state (OFF), the second switching device 36b is set in the connected state (ON), and the third switching device 40b is set in the connected state (ON).

In accordance with this feature, as shown in FIG. 12B, an electrical current (i1) flows from the first electrical power storage device 24a to the electrical power generating device 14 and the first load device 16a. Similarly, an electrical current (i2) flows from the second electrical power storage device 24b to the electrical power generating device 14 and the second load device 16b. An electrical charge is gradually stored in the smoothing capacitor 18 and the smoothing capacitors 20a and 20b, and as shown in FIG. 12A, a voltage (Vc) of the smoothing capacitor 18 and the smoothing capacitors 20a and 20b gradually rises. At time t2 in FIG. 12A and FIG. 12B, the voltage (Vc) of the smoothing capacitor 18 and the smoothing capacitors 20a and 20b reaches the same voltage as the terminal voltage (E2) of the second electrical power storage device 24b.

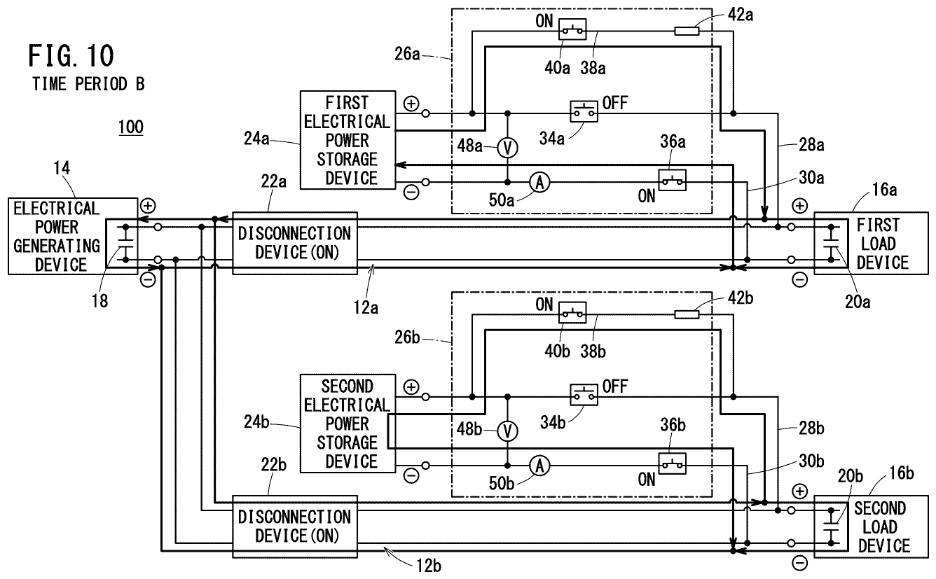

After the voltage (Vc) of the smoothing capacitor 18 and the smoothing capacitors 20a and 20b has reached the same voltage as the terminal voltage (E2) of the second electrical power storage device 24b, then as shown in FIG. 10, the electrical current (i1) flows from the first electrical power storage device 24a to the electrical power generating device 14 and the first load device 16a, and the electrical current (i1) flows from the first electrical power storage device 24a to the second electrical power storage device 24b. More specifically, charging of the smoothing capacitor 18 and the smoothing capacitors 20a and 20b, and charging of the second electrical power storage device 24b are carried out by the first electrical power storage device 24a.

If the charging of the smoothing capacitor 18 and the smoothing capacitors 20a and 20b by the first electrical power storage device 24a, and the charging of the second electrical power storage device 24b by the first electrical power storage device 24a are continued, the voltage (Vc) of the smoothing capacitor 18 and the smoothing capacitors 20a and 20b, and the terminal voltage (E2) of the second electrical power storage device 24b will become equal to the terminal voltage (E1) of the first electrical power storage device 24a. However, since the charging speed of the second electrical power storage device 24b is comparatively slow, a long time period is required until the voltage (Vc) of the smoothing capacitor 18 and the smoothing capacitors 20a and 20b, and the terminal voltage (E2) of the second electrical power storage device 24b become equal to the terminal voltage (E1) of the first electrical power storage device 24a.

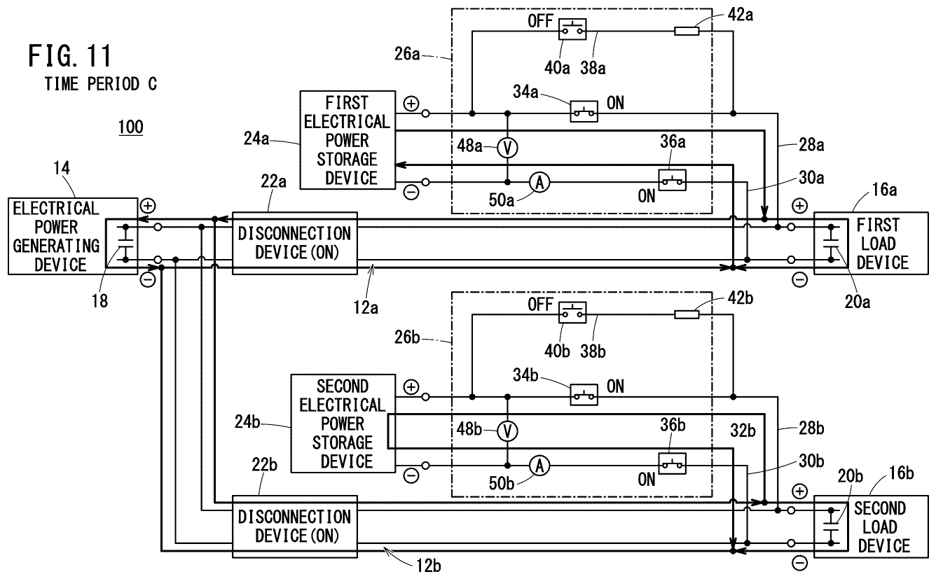

It is assumed that the system operation process is started at time t3 in FIG. 12A and FIG. 12B, which is a point in time prior to the equation E1=E2 becoming satisfied. When the system operation process is started, then as shown in FIG. 11, the pair of switching devices of the disconnection device 22a are set in the connected state (ON), the first switching device 34a is set in the connected state (ON), the second switching device 36a is set in the connected state (ON), and the third switching device 40a is set in the disconnected state (OFF). Further, when the system operation process is started, the pair of switching devices of the disconnection device 22b are set in the connected state (ON), the first switching device 34b is set in the connected state (ON), the second switching device 36b is set in the connected state (ON), and the third switching device 40b is set in the disconnected state (OFF).

In this case, since the first electrical power storage device 24a and the second electrical power storage device 24b are connected without any resistor intervening therebetween, an excessive electrical current is generated as shown in FIG. 12B. At this time, as shown in FIG. 12A, the terminal voltage (E2) of the second electrical power storage device 24b suddenly rises to the same voltage as the terminal voltage (E1) of the first electrical power storage device 24a.

As noted previously, in the electrical power supply system 100 of the comparative example, if the system operation process is started in a state of E1>E2, a concern arises in that an excessive electrical current will occur in the entire circuit of the electrical power supply system 100. In contrast thereto, according to the present embodiment, in the case that the inequality E1>E2 is satisfied at the point in time of the system shutdown process, it is possible to carry out discharging of the first electrical power storage device 24a without supplying an electrical power to the first load device 16a in the period until the subsequent startup preparation process. Therefore, according to the present embodiment, the system startup preparation process and the system operation process are not started in the state of E1>E2. Therefore, according to the present embodiment, it is possible to suppress an excessive electrical current caused by the situation in which the inequality E1>E2 is satisfied.

[Suppression of Occurrence of Excessive Electrical Current when Fourth Switching Devices Operate Erroneously]

According to the electrical power supply system 10 of the present embodiment, in the case that the fourth switching devices 46a and 46b operate erroneously, it is possible to suppress the occurrence of an excessive electrical current in the electrical power supply system 10.

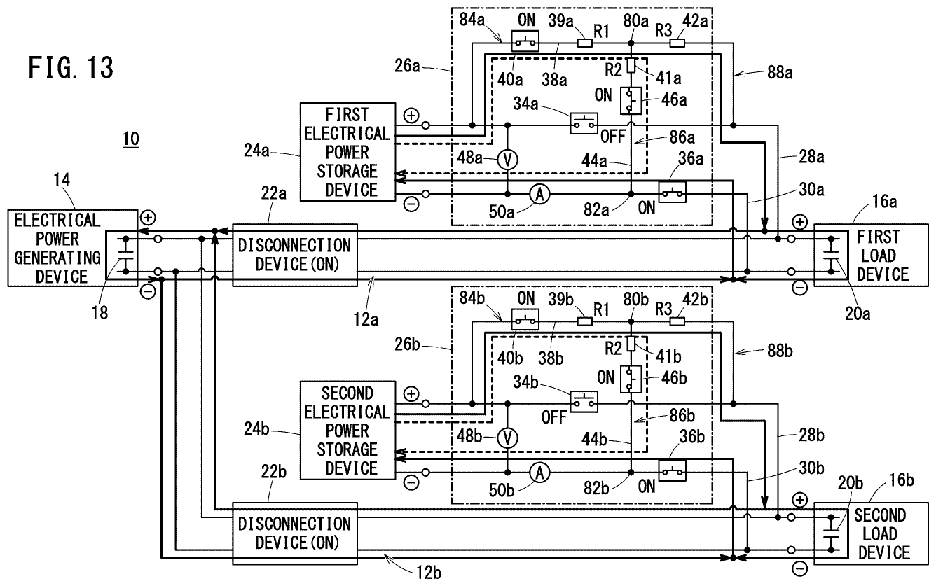

FIG. 13 is a diagram showing a state of the electrical power supply system 10 in the case that the fourth switching devices 46a and 46b operate erroneously during the system startup preparation process and have become placed in the connected state (ON).

During the system startup preparation process (FIG. 4), in the case that the fourth switching device 46a operates erroneously and has become placed in the connected state (ON), then as shown by the dashed line arrow in FIG. 13, a closed circuit is formed that runs from the first electrical power storage device 24a, by way of the third switching device 40a, the first resistor 39a, the second resistor 41a, and the fourth switching device 46a, and returns to the first electrical power storage device 24a. In this case, since the first resistor 39a and the second resistor 41a are included in the closed circuit, the positive electrode terminal and the negative electrode terminal of the first electrical power storage device 24a are not short circuited. Therefore, during the system startup preparation process, even in the case that the fourth switching device 46a operates erroneously and has become placed in the connected state (ON), an excessive electrical current will not flow through the electrical power supply system 10, and a loss of the first electrical power storage device 24a can be suppressed.

During the system startup preparation process (FIG. 4), in the case that the fourth switching device 46b operates erroneously and has become placed in the connected state (ON), then as shown by the dashed line arrow in FIG. 13, a closed circuit is formed that runs from the second electrical power storage device 24b, by way of the third switching device 40b, the first resistor 39b, the second resistor 41b, and the fourth switching device 46b, and returns to the second electrical power storage device 24b. In this case, since the first resistor 39b and the second resistor 41b are included in the closed circuit, the positive electrode terminal and the negative electrode terminal of the second electrical power storage device 24b are not short circuited. Therefore, during the system startup preparation process, even in the case that the fourth switching device 46b operates erroneously and has become placed in the connected state (ON), an excessive electrical current will not flow through the electrical power supply system 10, and a loss of the second electrical power storage device 24b can be suppressed.

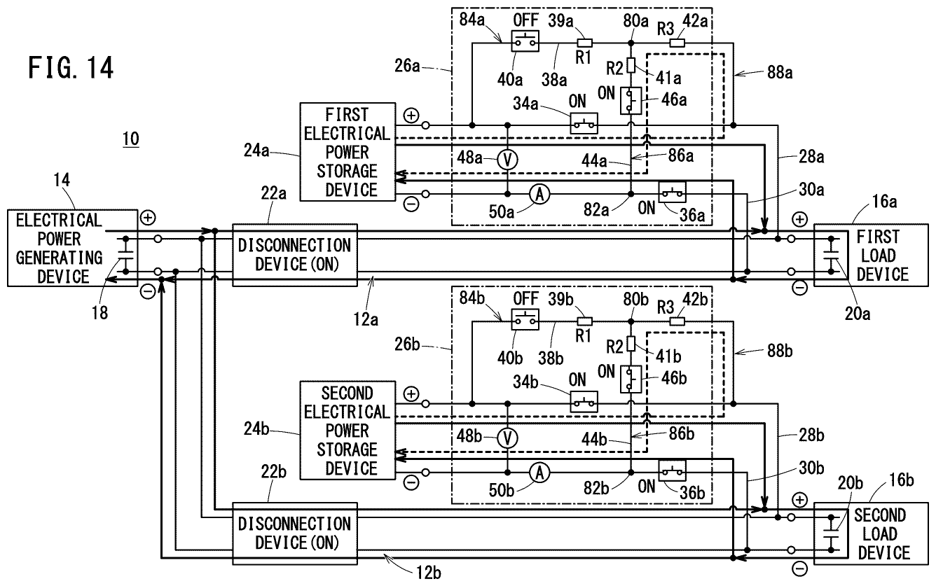

FIG. 14 is a diagram showing a state of the electrical power supply system 10 in the case that the fourth switching devices 46a and 46b operate erroneously during the system operation process and have become placed in the connected state (ON).

During the system operation process (FIG. 5), in the case that the fourth switching device 46a operates erroneously and has become placed in the connected state (ON), then as shown by the dashed line arrow in FIG. 14, a closed circuit is formed that runs from the first electrical power storage device 24a, by way of the first switching device 34a, the third resistor 42a, the second resistor 41a, and the fourth switching device 46a, and returns to the first electrical power storage device 24a. In this case, since the second resistor 41a and the third resistor 42a are included in the closed circuit, the positive electrode terminal and the negative electrode terminal of the first electrical power storage device 24a are not short circuited. Therefore, during the system operation process, even in the case that the fourth switching device 46a operates erroneously and has become placed in the connected state (ON), an excessive electrical current will not flow through the electrical power supply system 10, and a loss of the first electrical power storage device 24a can be suppressed.

During the system operation process (FIG. 5), in the case that the fourth switching device 46b operates erroneously and has become placed in the connected state (ON), then as shown by the dashed line arrow in FIG. 14, a closed circuit is formed that runs from the second electrical power storage device 24b, by way of the first switching device 34b, the third resistor 42b, the second resistor 41b, and the fourth switching device 46b, and returns to the second electrical power storage device 24b. In this case, since the second resistor 41b and the third resistor 42b are included in the closed circuit, the positive electrode terminal and the negative electrode terminal of the second electrical power storage device 24b are not short circuited. Therefore, during the system operation process, even in the case that the fourth switching device 46b operates erroneously and has become placed in the connected state (ON), an excessive electrical current will not flow through the electrical power supply system 10, and a loss of the second electrical power storage device 24b can be suppressed.

[Suppression of Occurrence of Excessive Electrical Current when Third Switching Devices Operate Erroneously]

According to the electrical power supply system 10 of the present embodiment, in the case that the third switching devices 40a and 40b operate erroneously, it is possible to suppress the occurrence of an excessive electrical current in the electrical power supply system 10.

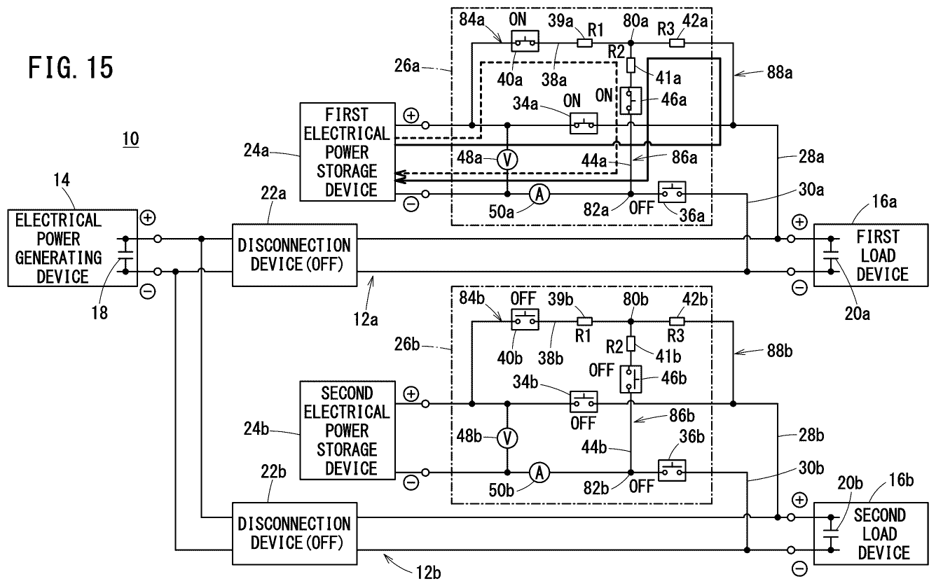

FIG. 15 is a diagram showing a state of the electrical power supply system 10 in the case that the third switching device 40a operates erroneously during the electrical power storage device discharging process and has become placed in the connected state (ON).

During the electrical power storage device discharging process (FIG. 8), in the case that the third switching device 40a operates erroneously and has become placed in the connected state (ON), then as shown by the dashed line arrow in FIG. 15, a closed circuit is formed that runs from the first electrical power storage device 24a, by way of the third switching device 40a, the first resistor 39a, the second resistor 41a, and the fourth switching device 46a, and returns to the first electrical power storage device 24a. In this case, since the first resistor 39a and the second resistor 41a are included in the closed circuit, the positive electrode terminal and the negative electrode terminal of the first electrical power storage device 24a are not short circuited. Therefore, during the electrical power storage device discharging process, even in the case that the third switching device 40a operates erroneously and has become placed in the connected state (ON), an excessive electrical current will not flow through the electrical power supply system 10, and a loss of the first electrical power storage device 24a can be suppressed.

During the electrical power storage device discharging process (FIG. 8), in the case that the third switching device 40b operates erroneously and has become placed in the connected state (ON) (this case being not shown), a closed circuit is formed that runs from the second electrical power storage device 24b, by way of the third switching device 40b, the first resistor 39b, the second resistor 41b, and the fourth switching device 46b, and returns to the second electrical power storage device 24b. In this case, since the first resistor 39b and the second resistor 41b are included in the closed circuit, the positive electrode terminal and the negative electrode terminal of the second electrical power storage device 24b are not short circuited. Therefore, during the electrical power storage device discharging process, even in the case that the third switching device 40b operates erroneously and has become placed in the connected state (ON), an excessive electrical current will not flow through the electrical power supply system 10, and a loss of the second electrical power storage device 24b can be suppressed.

### [Example of Using Electrical Power Supply System]

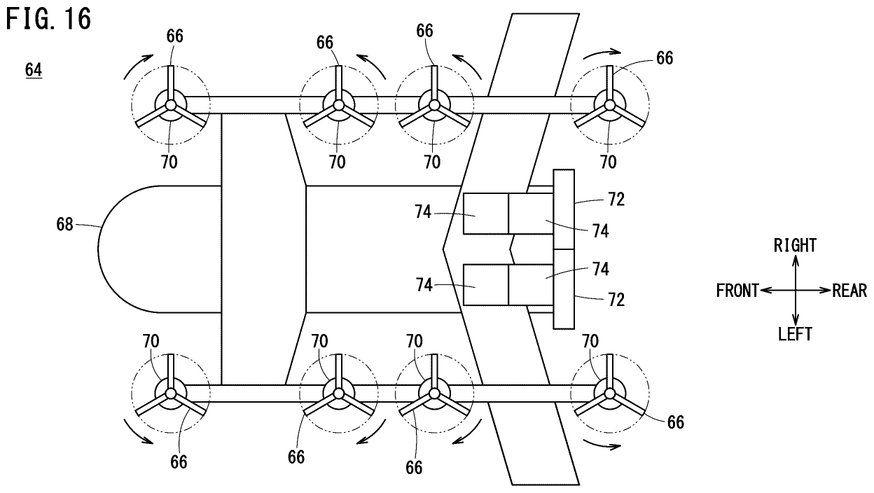

FIG. 16 is a schematic diagram of a moving object 64. The electrical power supply system 10 can be mounted in the moving object 64. The moving object 64, for example, is an electric vertical take-off and landing aircraft (eVTOL aircraft). The moving object 64 is equipped with eight VTOL rotors 66. The VTOL rotors 66 generate an upwardly directed thrust with respect to a fuselage 68. The moving object 64 is equipped with eight electric motors 70. One of the electric motors 70 drives one of the VTOL rotors 66. The moving object 64 includes two cruise rotors 72. The cruise rotors 72 generate a forwardly directed thrust with respect to the fuselage 68. The moving object 64 is equipped with four electric motors 74. Two of the electric motors 74 drive one of the cruise rotors 72.

Each of the first load device 16a and the second load device 16b may be equipped with at least one of a plurality of the electric motors 70 and a plurality of the electric motors 74. Each of the first load device 16a and the second load device 16b, in addition to the electric motors 70 and the electric motors 74, may be equipped with a low voltage driving device.

The moving object 64 is not limited to being an aircraft, but may be a ship, an automobile, a train, or the like. Further, in addition to the moving object 64, the electrical power supply system 10 may be used in facilities, factories, and the like.

### Second Embodiment

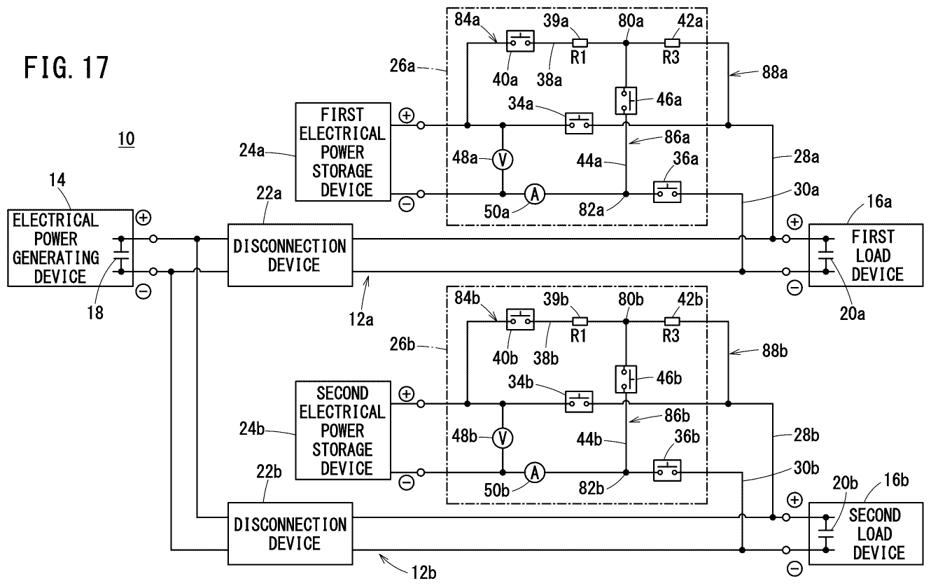

FIG. 17 is a schematic diagram of the electrical power supply system 10 according to the present embodiment. The electrical power supply system 10 according to the present embodiment differs from the electrical power supply system 10 according to the first embodiment, in that the former does not include the second resistors 41a and 41b that are provided in the electrical power supply system 10 according to the first embodiment. The other configurations of the electrical power supply system 10 according to the present embodiment are the same as those of the electrical power supply system 10 according to the first embodiment.

The resistance value (R1) of the first resistor 39a, and the resistance value (R3) of the third resistor 42a may be the same value or may be different values. The resistance value (R1+R3) in the closed circuit formed at a time when the smoothing capacitor 18 of the electrical power generating device 14 and the smoothing capacitor 20a of the first load device 16a are charged (precharged) becomes greater than the resistance value (R3) in the closed circuit formed at a time when the smoothing capacitor 18 of the electrical power generating device 14 and the smoothing capacitor 20a of the first load device 16a are discharged.

Similarly, the resistance value (R1) of the first resistor 39b, and the resistance value (R3) of the third resistor 42b may be the same value or may be different values. The resistance value (R1+R3) in the closed circuit formed at a time when the smoothing capacitor 18 of the electrical power generating device 14 and the smoothing capacitor 20b of the second load device 16b are charged (precharged) becomes greater than the resistance value (R3) in the closed circuit formed at a time when the smoothing capacitor 18 of the electrical power generating device 14 and the smoothing capacitor 20b of the second load device 16b are discharged.

### Third Embodiment

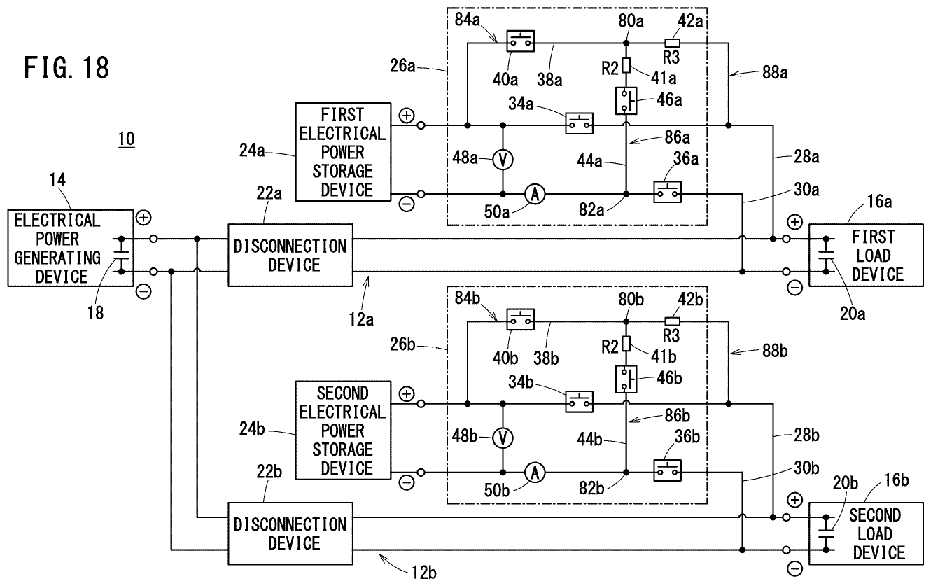

FIG. 18 is a schematic diagram of the electrical power supply system 10 according to the present embodiment. The electrical power supply system 10 according to the present embodiment differs from the electrical power supply system 10 according to the first embodiment, in that the former does not include the first resistors 39a and 39b that are provided in the electrical power supply system 10 according to the first embodiment. The other configurations of the electrical power supply system 10 according to the present embodiment are the same as those of the electrical power supply system 10 according to the first embodiment.

The resistance value (R2) of the second resistor 41a, and the resistance value (R3) of the third resistor 42a may be the same value or may be different values. The resistance value (R3) in the closed circuit formed at a time when the smoothing capacitor 18 of the electrical power generating device 14 and the smoothing capacitor 20a of the first load device 16a are charged (precharged) becomes less than the resistance value (R2+R3) in the closed circuit formed at a time when the smoothing capacitor 18 of the electrical power generating device 14 and the smoothing capacitor 20a of the first load device 16a are discharged.

Similarly, the resistance value (R2) of the second resistor 41b, and the resistance value (R3) of the third resistor 42b may be the same value or may be different values. The resistance value (R3) in the closed circuit formed at a time when the smoothing capacitor 18 of the electrical power generating device 14 and the smoothing capacitor 20b of the second load device 16b are charged (precharged) becomes less than the resistance value (R2+R3) in the closed circuit formed at a time when the smoothing capacitor 18 of the electrical power generating device 14 and the smoothing capacitor 20b of the second load device 16b are discharged.

### Fourth Embodiment

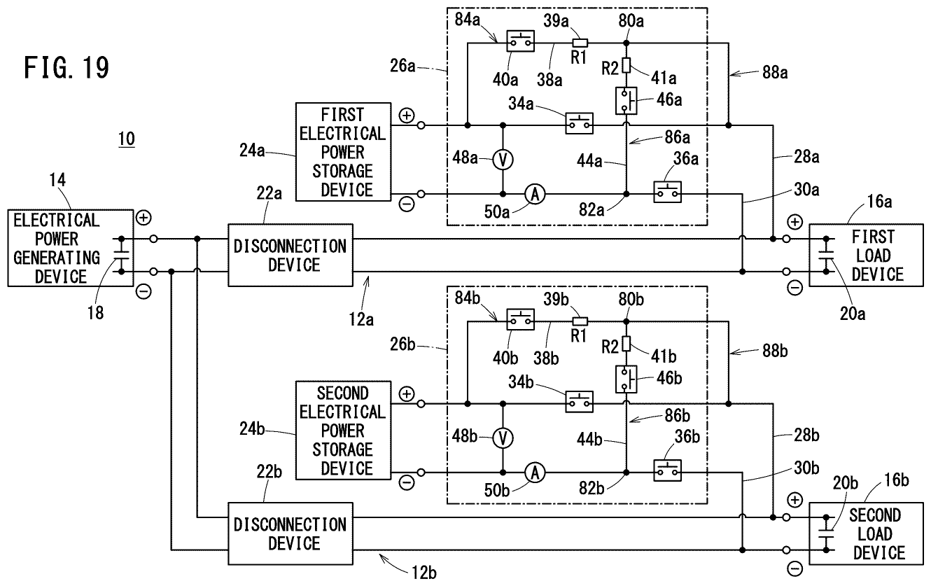

FIG. 19 is a schematic diagram of the electrical power supply system 10 according to the present embodiment. The electrical power supply system 10 according to the present embodiment differs from the electrical power supply system 10 according to the first embodiment, in that the former does not include the third resistors 42a and 42b that are provided in the electrical power supply system 10 according to the first embodiment. The other configurations of the electrical power supply system 10 according to the present embodiment are the same as those of the electrical power supply system 10 according to the first embodiment.

The resistance value (R1) of the first resistor 39a, and the resistance value (R2) of the second resistor 41a may be the same value or may be different values. In the closed circuit formed at a time when the smoothing capacitor 18 of the electrical power generating device 14 and the smoothing capacitor 20a of the first load device 16a are charged (precharged), the resistance value becomes R1, and in the closed circuit formed at a time when the smoothing capacitor 18 of the electrical power generating device 14 and the smoothing capacitor 20a of the first load device 16a are discharged, the resistance value becomes R2.

Similarly, the resistance value (R1) of the first resistor 39b, and the resistance value (R2) of the second resistor 41b may be the same value or may be different values. In the closed circuit formed at a time when the smoothing capacitor 18 of the electrical power generating device 14 and the smoothing capacitor 20b of the second load device 16b are charged (precharged), the resistance value becomes R1, and in the closed circuit formed at a time when the smoothing capacitor 18 of the electrical power generating device 14 and the smoothing capacitor 20b of the second load device 16b are discharged, the resistance value becomes R2.

### Fifth Embodiment

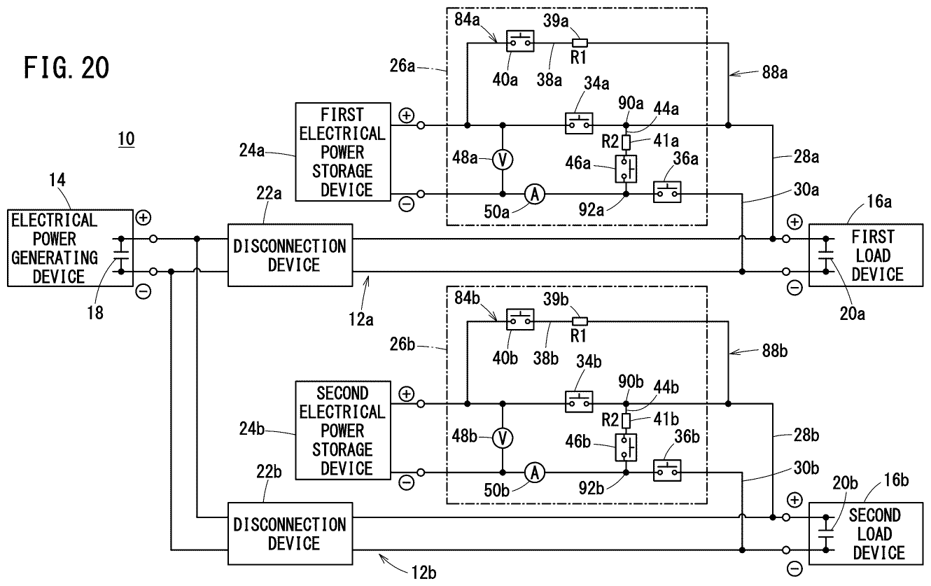

FIG. 20 is a schematic diagram of the electrical power supply system 10 according to the present embodiment. The electrical power supply system 10 according to the present embodiment differs from the electrical power supply system 10 according to the first embodiment, in that the former does not include the third resistors 42a and 42b that are provided in the electrical power supply system 10 according to the first embodiment. Further, in the electrical power supply system 10 of the present embodiment, the positions at which the fourth wires 44a and 44b are connected are different from the positions at which the fourth wires 44a and 44b are connected in the electrical power supply system 10 according to the first embodiment. The other configurations of the electrical power supply system 10 according to the present embodiment are the same as those of the electrical power supply system 10 according to the first embodiment.

One end of the fourth wire 44a is connected to the first wire 28a at a third node 90a, and another end of the fourth wire 44a is connected to the second wire 30a at a fourth node 92a. The third node 90a is positioned on the first wire 28a. The third node 90a is positioned at a location that is closer in proximity to the first load device 16a than the first switching device 34a. The fourth node 92a is positioned on the second wire 30a. The fourth node 92a is positioned at a location that is closer in proximity to the first electrical power storage device 24a than the second switching device 36a.

One end of the fourth wire 44b is connected to the first wire 28b at a third node 90b, and another end of the fourth wire 44b is connected to the second wire 30b at a fourth node 92b. The third node 90b is positioned on the first wire 28b. The third node 90b is positioned at a location that is closer in proximity to the second load device 16b than the first switching device 34b. The fourth node 92b is positioned on the second wire 30b. The fourth node 92b is positioned at a location that is closer in proximity to the second electrical power storage device 24b than the second switching device 36b.

A resistance value (R1) of the first resistor 39a, and a resistance value (R2) of the second resistor 41a may be the same value or may be different values. In the closed circuit formed at a time when the smoothing capacitor 18 of the electrical power generating device 14 and the smoothing capacitor 20a of the first load device 16a are charged (precharged), the resistance value becomes R1, and in the closed circuit formed at a time when the smoothing capacitor 18 of the electrical power generating device 14 and the smoothing capacitor 20a of the first load device 16a are discharged, the resistance value becomes R2.

Similarly, the resistance value (R1) of the first resistor 39b, and the resistance value (R2) of the second resistor 41b may be the same value or may be different values. In the closed circuit formed at a time when the smoothing capacitor 18 of the electrical power generating device 14 and the smoothing capacitor 20b of the second load device 16b are charged (precharged), the resistance value becomes R1, and in the closed circuit formed at a time when the smoothing capacitor 18 of the electrical power generating device 14 and the smoothing capacitor 20b of the second load device 16b are discharged, the resistance value becomes R2.

Moreover, the circuit of the electrical power supply system 10 according to the present embodiment (FIG. 20) and the circuit of the electrical power supply system 10 according to the fourth embodiment (FIG. 19) are electrically equivalent circuits.

In relation to the above-described disclosure, the following supplementary notes are further disclosed.

### Supplementary Note 1

The electrical power supply system (10) according to the present disclosure includes the electrical power supply circuit that supplies the electrical power from the electrical power storage device (24a) to the load device (16a), the electrical power supply system comprising the first wire (28a) which is one wire from among the positive wire and the negative wire provided in the electrical power supply circuit, the first switching device (34a) that is disposed on the first wire, and switches between the connected state in which the electrical power storage device and the load device are connected, and the disconnected state in which the electrical power storage device and the load device are disconnected, the second wire (30a) which is another wire from among the positive wire and the negative wire, the second switching device (36a) that is disposed on the second wire, and switches between the connected state in which the electrical power storage device and the load device are connected, and the disconnected state in which the electrical power storage device and the load device are disconnected, the third wire (38a) that bypasses the first switching device, the third switching device (40a) that is disposed on the third wire, and switches between the connected state in which the electrical power storage device and the load device are connected, and the disconnected state in which the electrical power storage device and the load device are disconnected, the fourth wire (44a) that is connected to the third wire at the first node (80a) that is closer in proximity to the load device than the third switching device, and that is connected to the second wire at the second node (82a) that is closer in proximity to the electrical power storage device than the second switching device, the fourth switching device (46a) that is disposed on the fourth wire, and switches between the connected state in which the third wire and the second wire are connected, and the disconnected state in which the third wire and the second wire are disconnected, and the resistors disposed in at least two portions from among the first portion (84a) which is a portion of the third wire that is positioned between the electrical power storage device and the first node, the second portion (86a) which is a portion on the fourth wire, and the third portion (88a) which is a portion of the third wire that is positioned between the first node and the load device. In accordance with such features, during charging (precharging) of the load device, even in the case that the second wire and the third wire are connected by the fourth wire due to an erroneous operation of the fourth switching device, an excessive electrical current does not flow through the electrical power supply system, and a loss of the electrical power storage device can be suppressed.

### Supplementary Note 2

In the electrical power supply system according to supplementary note 1, the resistors may be disposed in the first portion, the second portion, and the third portion. In accordance with this feature, during charging (precharging) of the load device, even in the case that the second wire and the third wire are connected by the fourth wire due to an erroneous operation of the fourth switching device, an excessive electrical current does not flow through the electrical power supply system, and a loss of the electrical power storage device can be suppressed.

### Supplementary Note 3

In the electrical power supply system according to supplementary note 1, the resistors may be disposed in the first portion and the second portion. In accordance with this feature, during charging (precharging) of the load device, even in the case that the second wire and the third wire are connected by the fourth wire due to an erroneous operation of the fourth switching device, an excessive electrical current does not flow through the electrical power supply system, and a loss of the electrical power storage device can be suppressed.

### Supplementary Note 4

In the electrical power supply system according to supplementary note 1, the resistors may be disposed in the second portion and the third portion. In accordance with this feature, during charging (precharging) of the load device, even in the case that the second wire and the third wire are connected by the fourth wire due to an erroneous operation of the fourth switching device, an excessive electrical current does not flow through the electrical power supply system, and a loss of the electrical power storage device can be suppressed.

### Supplementary Note 5

In the electrical power supply system according to supplementary note 1, the resistors may be disposed in the first portion and the third portion. In accordance with this feature, during charging (precharging) of the load device, even in the case that the second wire and the third wire are connected by the fourth wire due to an erroneous operation of the fourth switching device, an excessive electrical current does not flow through the electrical power supply system, and a loss of the electrical power storage device can be suppressed.

### Supplementary Note 6

The electrical power supply system according to the present disclosure includes the electrical power supply circuit that supplies the electrical power from the electrical power storage device to the load device, the electrical power supply system comprising the first wire which is one wire from among the positive wire and the negative wire provided in the electrical power supply circuit, the first switching device that is disposed on the first wire, and switches between the connected state in which the electrical power storage device and the load device are connected, and the disconnected state in which the electrical power storage device and the load device are disconnected, the second wire which is another wire from among the positive wire and the negative wire, the second switching device that is disposed on the second wire, and switches between the connected state in which the electrical power storage device and the load device are connected, and the disconnected state in which the electrical power storage device and the load device are disconnected, the third wire that bypasses the first switching device, the third switching device that is disposed on the third wire, and switches between the connected state in which the electrical power storage device and the load device are connected, and the disconnected state in which the electrical power storage device and the load device are disconnected, the first resistor (39a) disposed on the third wire, and connected in series with the third switching device, the fourth wire that is connected to the first wire at the third node (90a) that is closer in proximity to the load device than the first switching device, and that is connected to the second wire at the fourth node (92a) that is closer in proximity to the electrical power storage device than the second switching device, the fourth switching device that is disposed on the fourth wire, and switches between the connected state in which the third wire and the second wire are connected, and the disconnected state in which the third wire and the second wire are disconnected, and the second resistor (41a) disposed on the fourth wire, and connected in series with the fourth switching device. In accordance with such features, during charging (precharging) of the load device, even in the case that the first wire and the second wire are connected by the fourth wire due to an erroneous operation of the fourth switching device, an excessive electrical current does not flow through the electrical power supply system, and a loss of the electrical power storage device can be suppressed.

### Supplementary Note 7

In the electrical power supply system according to any one of supplementary notes 1 to 6, the load device includes the smoothing capacitor (20a), and in the case that the smoothing capacitor is charged, the first switching device may be set in the disconnected state, the second switching device may be set in the connected state, the third switching device may be set in the connected state, and the fourth switching device may be set in the disconnected state. In accordance with this feature, it is possible to carry out charging of the smoothing capacitor of the load device.

### Supplementary Note 8

In the electrical power supply system according to any one of supplementary notes 1 to 6, in the case that the electrical power is supplied from the electrical power storage device to the load device, the first switching device may be set in the connected state, the second switching device may be set in the connected state, the third switching device may be set in the disconnected state, and the fourth switching device may be set in the disconnected state. In accordance with this feature, the electrical power can be supplied from the electrical power storage device to the load device.

### Supplementary Note 9

In the electrical power supply system according to any one of supplementary notes 1 to 6, the load device includes the smoothing capacitor, and in the case that the smoothing capacitor is discharged, the first switching device may be set in the disconnected state, the second switching device may be set in the connected state, the third switching device may be set in the disconnected state, and the fourth switching device may be set in the connected state. In accordance with this feature, it is possible to carry out discharging of the smoothing capacitor of the load device.

### Supplementary Note 10

In the electrical power supply system according to any one of supplementary notes 1 to 6, in the case that the electrical power storage device is discharged, the first switching device may be set in the connected state, the second switching device may be set in the disconnected state, the third switching device may be set in the disconnected state, and the fourth switching device may be set in the connected state. In accordance with this feature, it is possible to carry out discharging of the electrical power storage device.

### Supplementary Note 11

The electrical power supply system according to supplementary note 9 may further comprise the internal resistance value acquisition unit (61) that acquires the internal resistance value of the electrical power storage device, based on the terminal voltage of the electrical power storage device in a non-discharging state, the terminal voltage of the electrical power storage device during discharging thereof, and the electrical current of the electrical power storage device during discharging thereof. In accordance with this feature, it is possible to estimate the degree of deterioration of the electrical power storage device.

### Supplementary Note 12

The moving object (64) according to the present disclosure comprises the electrical power supply system according to any one of supplementary notes 1 to 6. In accordance with this feature, an excessive electrical current does not flow through the electrical power supply system of the moving object, and a loss of the electrical power storage device can be suppressed.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the gist of the present disclosure as derived from the contents described in the claims and equivalents thereof. Further, the embodiments can also be implemented together in combination. For example, in the above-described embodiments, the order of the operations and the order of the processes are illustrated as examples, and the present disclosure is not necessarily limited to these features. The same also applies to cases in which numerical values or mathematical expressions are used in the description of the aforementioned embodiments.

1. An electrical power supply system including an electrical power supply circuit configured to supply electrical power from an electrical power storage device to a load device, the electrical power supply system comprising:
a first wire which is one wire from among a positive wire and a negative wire provided in the electrical power supply circuit;
a first switching device disposed on the first wire, and configured to switch between a connected state in which the electrical power storage device and the load device are connected, and a disconnected state in which the electrical power storage device and the load device are disconnected;
a second wire which is another wire from among the positive wire and the negative wire;
a second switching device disposed on the second wire, and configured to switch between a connected state in which the electrical power storage device and the load device are connected, and a disconnected state in which the electrical power storage device and the load device are disconnected;
a third wire configured to bypass the first switching device;
a third switching device disposed on the third wire, and configured to switch between a connected state in which the electrical power storage device and the load device are connected, and a disconnected state in which the electrical power storage device and the load device are disconnected;
a fourth wire configured to be connected to the third wire at a first node that is closer in proximity to the load device than the third switching device, and configured to be connected to the second wire at a second node that is closer in proximity to the electrical power storage device than the second switching device;
a fourth switching device disposed on the fourth wire, and configured to switch between a connected state in which the third wire and the second wire are connected, and a disconnected state in which the third wire and the second wire are disconnected; and
resistors disposed in at least two portions from among a first portion which is a portion of the third wire that is positioned between the electrical power storage device and the first node, a second portion which is a portion on the fourth wire, and a third portion which is a portion of the third wire that is positioned between the first node and the load device.

2. The electrical power supply system according to claim 1, wherein the resistors are disposed in the first portion, the second portion, and the third portion.

3. The electrical power supply system according to claim 1, wherein the resistors are disposed in the first portion and the second portion.

4. The electrical power supply system according to claim 1, wherein the resistors are disposed in the second portion and the third portion.

5. The electrical power supply system according to claim 1, wherein the resistors are disposed in the first portion and the third portion.

6. An electrical power supply system including an electrical power supply circuit configured to supply electrical power from an electrical power storage device to a load device, the electrical power supply system comprising:
a first wire which is one wire from among a positive wire and a negative wire provided in the electrical power supply circuit;
a first switching device disposed on the first wire, and configured to switch between a connected state in which the electrical power storage device and the load device are connected, and a disconnected state in which the electrical power storage device and the load device are disconnected;
a second wire which is another wire from among the positive wire and the negative wire;
a second switching device disposed on the second wire, and configured to switch between a connected state in which the electrical power storage device and the load device are connected, and a disconnected state in which the electrical power storage device and the load device are disconnected;
a third wire configured to bypass the first switching device;
a third switching device disposed on the third wire, and configured to switch between a connected state in which the electrical power storage device and the load device are connected, and a disconnected state in which the electrical power storage device and the load device are disconnected;
a first resistor disposed on the third wire, and configured to be connected in series with the third switching device;
a fourth wire configured to be connected to the first wire at a third node that is closer in proximity to the load device than the first switching device, and configured to be connected to the second wire at a fourth node that is closer in proximity to the electrical power storage device than the second switching device;
a fourth switching device disposed on the fourth wire, and configured to switch between a connected state in which the third wire and the second wire are connected, and a disconnected state in which the third wire and the second wire are disconnected; and
a second resistor disposed on the fourth wire, and configured to be connected in series with the fourth switching device.

7. The electrical power supply system according to claim 1, wherein:
the load device includes a smoothing capacitor; and
in a case that the smoothing capacitor is charged, the first switching device is set in the disconnected state, the second switching device is set in the connected state, the third switching device is set in the connected state, and the fourth switching device is set in the disconnected state.

8. The electrical power supply system according to claim 1, wherein, in a case that electrical power is supplied from the electrical power storage device to the load device, the first switching device is set in the connected state, the second switching device is set in the connected state, the third switching device is set in the disconnected state, and the fourth switching device is set in the disconnected state.

9. The electrical power supply system according to claim 1, wherein:
the load device includes a smoothing capacitor; and
in a case that the smoothing capacitor is discharged, the first switching device is set in the disconnected state, the second switching device is set in the connected state, the third switching device is set in the disconnected state, and the fourth switching device is set in the connected state.

10. The electrical power supply system according to claim 1, wherein, in a case that the electrical power storage device is discharged, the first switching device is set in the connected state, the second switching device is set in the disconnected state, the third switching device is set in the disconnected state, and the fourth switching device is set in the connected state.

11. The electrical power supply system according to claim 9, comprising one or more processors that execute computer-executable instructions stored in a memory,
wherein the one or more processors execute the computer-executable instructions to cause the electrical power supply system to acquire an internal resistance value of the electrical power storage device, based on a terminal voltage of the electrical power storage device in a non-discharging state, the terminal voltage of the electrical power storage device during discharging of the electrical power storage device, and an electrical current of the electrical power storage device during discharging of the electrical power storage device.

12. A moving object comprising the electrical power supply system according to claim 1.
